(19) United States
(12) Patent Application Publication
(10) Pub. No.: US 2003/0136279 A1
(43) Pub. Date: Jul. 24, 2003

(54) Vacuum compacting trash can

(76) Inventor: Kenneth A. Tarlow, Corte Madera, CA (US)

Correspondence Address: KENNETH A. TARLOW, 21 GOLDEN HIND PSG., CORTE MADERA, CA, 94925, US

(21) Appl. No.: 10/051,949

(22) Filed: Jan. 22, 2002

(51) Int. Cl. B30B 9/00

(52) U.S. Cl. 100/90

(57) ABSTRACT

Vacuum Compacting Trash Can with a standard trash can having a hollow vessel and a vessel capping lid, the lid having a latching means to retain it to the vessel, the trash vessel containing a vacuum pump, a vacuum holding tank, a vacuum pressure switch, a solenoid valve, an electrical “on” switch, a vacuum hose, a power cord and plug, a collapsible bag having a resilient gasket surrounding its upper lip, the resilient gasket capable of communicating with the underside of said vessel lid in an air tight fashion, and a means for removably retaining a plastic trash bag within said collapsible bag. A preferred embodiment includes wherein said vacuum pump and said vacuum holding tank are positioned at the bottom of the inside of said vessel and a vacuum hose travels from said vacuum holding tank and the underside of said vessel capping lid, said collapsible bag having a plurality of horizontally disposed accordion pleats so that when a standard trash plastic trash bag is installed within said collapsible bag and the air is vacuumed out of said collapsible bag, the standard plastic bag and the contents therein are compacted by the fact that the air within said standard plastic bag is being forcibly removed.

### BACKGROUND OF THE INVENTION

This invention relates generally to the field of trash cans, and more particularly to a vacuum compacting trash can.

Trash cans have been in existence for hundreds of years. More recently, with the proliferation of trash and the simultaneous reduction in landfill locations to dispose of trash, trash compactors have been designed for home use.

These compactors are usually installed when the kitchen counters and other appliances such as dish washers and the like are installed. The compactors use a motor and lead screw mechanism to forceably push a plate down on the trash to reduce its bulk.

The current trash compactors are expensive to purchase and expensive to install under a kitchen counter. Additionally, they can not be easily moved to alternate locations.

### SUMMARY OF THE INVENTION

The primary object of the invention is to provide a trash can that has the ability to quickly reduce the size of trash holding plastic bags by removing the excess air from said plastic bag.

Other objects and advantages of the present invention will become apparent from the following descriptions, taken in connection with the accompanying drawings, wherein, by way of illustration and example, an embodiment of the present invention is disclosed.

Vacuum Compacting Trash Can comprising: a standard trash can having a hollow vessel and a vessel capping lid, said lid having a latching means to retain it to said vessel, said trash vessel containing a vacuum pump, a vacuum holding tank, a vacuum pressure switch, a solenoid valve, an electrical “on” switch, a vacuum hose, a power cord and plug, a collapsible bag having a resilient gasket surrounding its upper lip, said resilient gasket capable of communicating with the underside of said vessel lid in an air tight fashion, and a means for removably retaining a plastic trash bag within said collapsible bag.

The drawings constitute a part of this specification and include exemplary embodiments to the invention, which may be embodied in various forms. It is to be understood that in some instances various aspects of the invention may be shown exaggerated or enlarged to facilitate an understanding of the invention.

### BRIEF DESCRIPTION OF THE DRAWINGS

FIG. 1 is a perspective view of the vacuum operated trash can of the present invention.

FIG. 2 is a side section view of the present invention with the collapsible bag in the extended position.

FIG. 3 is a side section view of the present invention with the collapsible bag in the compressed position.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

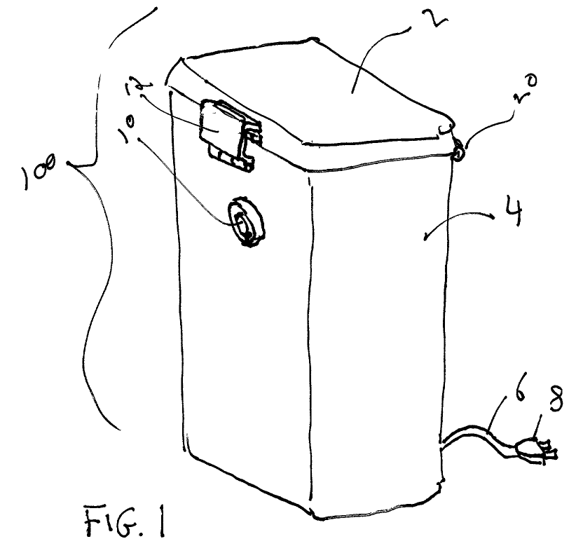

Referring now to FIG. 1 we see a perspective view of the vacuum compacting trash can of the present invention 100. A main vessel 4 is topped by a hinged 20 lid 2. Lid to is held down by removable and replaceable standard latch 12. From an exterior view, the trash can of the present invention looks similar to a standard trash can except for the push button 10 located on the front surface and the line cord 6 and plug 8 extending from its lower surface

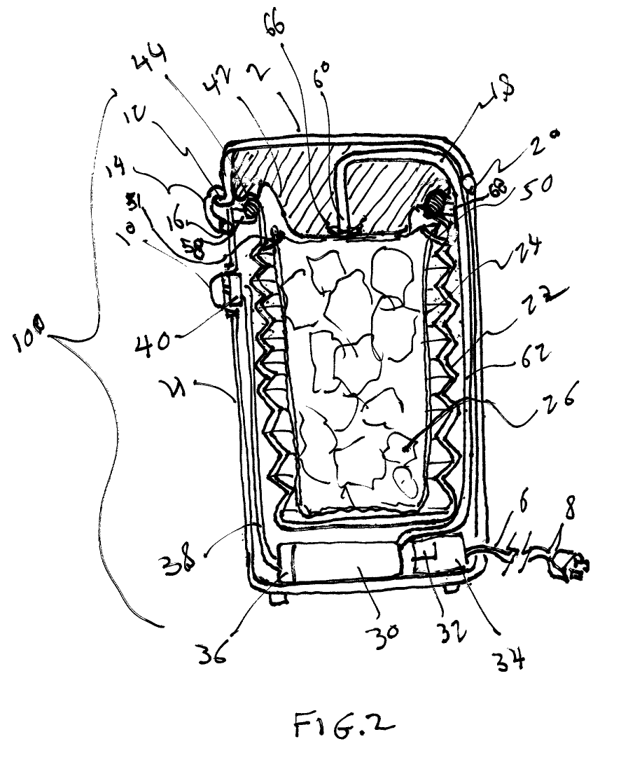

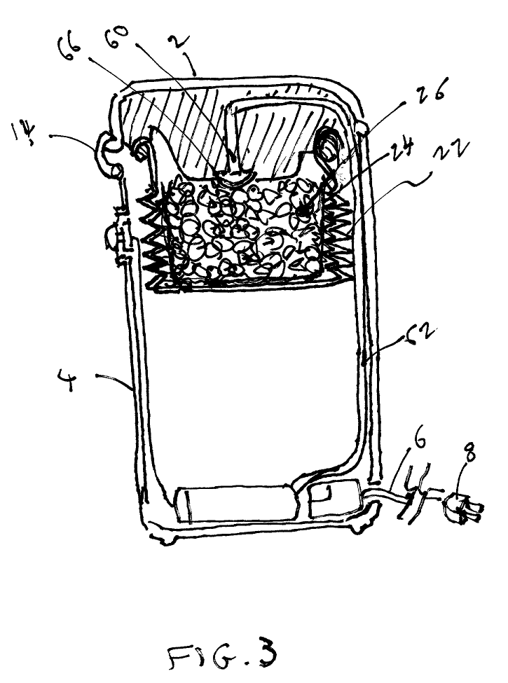

FIG. 2 shows a side section view of the trash can of the present invention 100. In this view we can see, at its lower portion, a vacuum pump 34 and associated vacuum pressure switch 32, vacuum holding tank 30 as well as a solenoid valve 36. A flexible, but not collapsible vacuum tube 18 extends from the vacuum holding tank 30 to the vessel lid 2 and ends at lower inside lid portion 60. The opening of vacuum tube 62,18 is protected from debris by a screen 66 An “on” switch 40 is located on the inside wall of vessel 4 and is activated by push button 10 located on the outside wall of vessel 4. A power cord 6 and plug 8 extend from the vacuum pump 34 and provide power to the pump 34. Alternately the pump may be powered by batteries that would be internal to the vessel 4. Brackets 58, 68 hold resilient gasket 44 in place. Gasket 44 is fixedly connected to the top lip of collapsible bag 22. Bag 22 is able to be collapsed in an upward direction due to the plurality of horizontally disposed accordion like pleats in its construction. A plurality of upwardly slanting spikes 50, 51 are placed around the circumference of the upper portion of the collapsible bag 22. These spikes 50, 51 are capable of holding up a standard plastic trash bag 26 by piercing the bag 26 at each spike location. The user can operate the trash can of the present invention just like an ordinary trash can. However, when the inner plastic trash bag is full, the user can activate the vacuum holding tank 30 and vacuum pump 34 by pushing button 10 which causes solenoid valve 36 to open and vacuum pup 34 to turn on thereby allowing vacuum pressure to flow from vacuum tube 62 into holding tank 30. By activating the vacuum tank 30 and pump 34, the collapsible bag 22 is caused to be drawn up as the air present in the bag 22 is removed through vacuum tube 62. This in turn causes the air contained in plastic trash bag 24 to be squeezed out thereby compressing the trash 26 stored within bag 24 as shown in FIG. 3. The user can then unlatch fastener 14 and lift lid 2 to remove the compacted trash bag 24. When the lid 2 is opened, it releases the vacuum created within and causes the the accordion pleats collapsible bag 24 to spring back to return to their normal extended position as shown in FIG. 2. The user can then remove the compacted plastic trash bag 24 and replace it with a new, empty trash bag. As the vacuum is released from the vacuum holding tank 30, pressure switch 32 turns on vacuum pump 34 until the vacuum tank 30 is replenshed at which point, the pressure switch 32 automaticly turns off vacuum pump 34

In the above described and illustrated way, a person can fill the trash can of the

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. Vacuum Compacting Trash Can comprising:
a standard trash can having a hollow, vessel and a vessel capping lid;
said lid having a latching means to retain it to said vessel;
said trash vessel containing
a vacuum pump,
a vacuum holding tank,
a vacuum pressure switch,
a solenoid valve,
an electrical “on” switch,
a vacuum hose,
a power cord and plug,
a collapsible bag having a resilient gasket surrounding its upper lip,
said resilient gasket capable of communicating with the underside of said vessel lid in an air tight fashion;
and means for removably retaining a plastic trash bag within said collapsible bag.

2. Vacuum Compacting Trash Can as claimed in claim 1 wherein said vacuum pump and said vacuum holding tank are positioned at the bottom of the inside of said vessel and a vacuum hose travels from said vacuum holding tank and the underside of said vessel capping lid;
said collapsible bag having a plurality of horizontally disposed accordion pleats so that when a standard trash plastic trash bag is installed within said collapsible bag and the air is vacuumed out of said collapsible bag, the standard plastic bag and the contents therein are compacted by the fact that the air within said standard plastic bag is being forcibly removed.
